(19) United States
(12) Patent Application Publication
(10) Pub. No.: US 2024/0329232 A1
(43) Pub. Date: Oct. 3, 2024

(54) SYSTEMS AND METHODS FOR NON-INVASIVE SCREENING OF INDIVIDUALS

(71) Applicant: Leidos Security Detection & Automation, Inc., Tewksbury, MA (US)

(72) Inventors: Nicholas E. Ortyl, III, Bedford, MA (US); Andrew D. Foland, Wellesley, MA (US); Michael H. Schmitt, Pinellas Park, FL (US)

(21) Appl. No.: 18/126,795

(22) Filed: Mar. 27, 2023

Related U.S. Application Data
(60) Provisional application No. 63/323,840, filed on Mar. 25, 2022.

(51) Int. Cl. G01S 13/88; G01S 7/02; G01S 13/00; G01S 13/86

(52) U.S. Cl. CPC G01S 13/887; G01S 7/027; G01S 13/003; G01S 13/86

(57) ABSTRACT

Systems and methods described herein provide systems for scanning an individual to identify hidden objects carried by the individual. The systems and methods employ imaging masts with transmitters and receivers of electromagnetic radiation. First and second imaging masts transmit and receive radiation on first and second scan paths, respectively, about a central point. The first and second scan paths are in a mirror-image arrangement with respect to the central point. The geometry of the imaging mast scan paths enables the use of multistatic reconstruction algorithms and improved data acquisition as compared to conventional systems and methods.

### RELATED APPLICATIONS

This application claims priority to U.S. Provisional Patent Application No. 63/323,840, filed on Mar. 25, 2022, which is hereby incorporated by reference in its entirety.

### BACKGROUND

Non-contact screening is an important tool to detect the presence of contraband or hazardous items being carried by an individual entering a restricted area or transportation hub such as a secure building, an airport, or a train station. Various technologies have been used for non-contact screening including x-ray and millimeter-wave imaging. Such technologies can be used to produce images that reveal hidden objects carried on a person that are not visible to plain sight.

### SUMMARY

A scanning system is presented. The scanning system includes a first imaging mast including a first plurality of electromagnetic radiation transmitters and a first plurality of electromagnetic radiation receivers. The first imaging mast is configured to move past a first side of an object positioned along a central horizontal axis to image at least a first portion of the object. The scanning system includes a second imaging mast including a second plurality of electromagnetic radiation transmitters and a second plurality of electromagnetic radiation receivers. The second imaging mast is configured to move past a second side of the object to image at least a second portion of the object. The first imaging mast and the second imaging mast are configured to move in unison in a common horizontal direction relative to the central horizontal axis. The scanning system includes a computing device including a processing unit. The computing device is configured to execute instructions to receive imaging data from the first imaging mast, the second imaging mast, or both imaging masts. The imaging data is representative of electromagnetic radiation reflected or scattered by the object as the first imaging mast and the second imaging mast move past the object. The computing device is configured to execute instructions to apply a reconstruction algorithm to the imaging data to produce an image of at least a portion of the object.

A method of scanning an object is presented. The method includes transmitting electromagnetic radiation from one of a plurality of transmitters of a first imaging mast or a second imaging mast. The method includes receiving, at a computing device, imaging data indicative of receiving electromagnetic radiation scattered or reflected from the object by a plurality of first receivers of the first imaging mast and a plurality of second receivers of the second imaging mast. The method includes moving the first imaging mast and the second imaging mast in unison in a common horizontal direction relative to a central horizontal axis. The method includes reconstructing an image of the object by applying a multistatic reconstruction algorithm of the computing device to the imaging data.

### BRIEF DESCRIPTION OF DRAWINGS

Illustrative embodiments are shown by way of example in the accompanying drawings and should not be considered as a limitation of the present disclosure.

FIG. 1 schematically illustrates a top view of a prior art system for screening of individuals to detect hidden objects.

FIG. 2 schematically illustrates a top view of a millimeter wave scanning system for screening individuals to detect hidden objects that uses cylindrical mast motion according to some embodiments described herein.

FIG. 3 schematically illustrates a top view of transmission and reception of electromagnetic radiation at a same mast in accordance with some embodiments described herein.

FIG. 4 schematically illustrates a top view of transmission of electromagnetic radiation from the first mast and receiving of electromagnetic radiation at a second mast in accordance with some embodiments described herein.

FIG. 5 schematically illustrates a top view of a millimeter wave scanning system for screening individuals to detect hidden objects that uses linear mast motion according to some embodiments described herein.

FIGS. 6A-6C schematically illustrate a motion sequence for linear-moving masts that undergo rotation while moving according to some embodiments described herein.

FIG. 7 schematically illustrates a top view of a millimeter wave scanning system for screening individuals to detect hidden objects that includes non-translating masts and reflectors according to some embodiments described herein.

FIGS. 8A and 8B illustrate perspective and front views of an imaging mast for use with some embodiments of systems and methods of the present disclosure.

FIG. 9 schematically illustrates a non-invasive walk-through metal detector for use with some embodiments of systems and methods of the present disclosure.

FIG. 10 schematically illustrates a computing device for use with some embodiments described herein.

FIG. 11 schematically illustrates a network environment for use with the systems and methods of some embodiments described herein.

FIG. 12 illustrates a method of scanning an individual to detect hidden objects using embodiments of the systems described herein.

### DETAILED DESCRIPTION

Described in detail herein are systems and methods for non-invasive step-through screening of individuals for contraband. The systems and methods employ full-body imaging systems that are configured to improve the scanning experience for the user while providing rapid throughput of individuals overall. High scanning throughput is desirable to reduce wait times for individuals awaiting screening. In conventional imaging systems, the individual enters a chamber and turns to face a side direction orthogonal to the directions of entry and exit. The individual must place his or her hands over his or her head and hold in a still position for a set amount of time while the imaging scanner moves to cover multiple view angles around the individual. The individual can then lower his or her hands, turn back to face the exit, and exit from the chamber. This multi-step process must be communicated to each screened individual, and the time to complete an individual scan can increase if the individual requires additional help or re-instruction.

Systems and methods of the present disclosure improve the user experience by allowing individuals to step into the chamber and continue facing the forward direction (e.g., towards the exit) throughout the scanning process. The imaging masts transmit and receive electromagnetic radiation on scan paths that are mirrored across the person. This arrangement of the scan paths enables cross-mast transmission and reception and enables powerful multistatic reconstruction algorithms. The increased amount of imaging data over a larger variety of scattering angles in systems of the present disclosure enable scanning of forward-facing individuals, larger chambers with wider entrances and exits to accommodate individuals with mobility impairments, and greater throughput as the scan paths can be shorter given the increased data throughput.

As used herein, a “scan path” is a trajectory through a collection of points from which electromagnetic radiation is directed towards an object to be imaged (such as an individual) or along which electromagnetic radiation reflected or scattered from the object to be imaged. The scan path can be physically traced out by the motion of a transmitter or receiver of electromagnetic radiation in some embodiments. In other embodiments, the scan path is a trajectory through a collection of points that represent virtual or apparent transmitters or receivers of electromagnetic radiation (i.e., points along a surface of a reflector that all focus to a common transmitter or receiver).

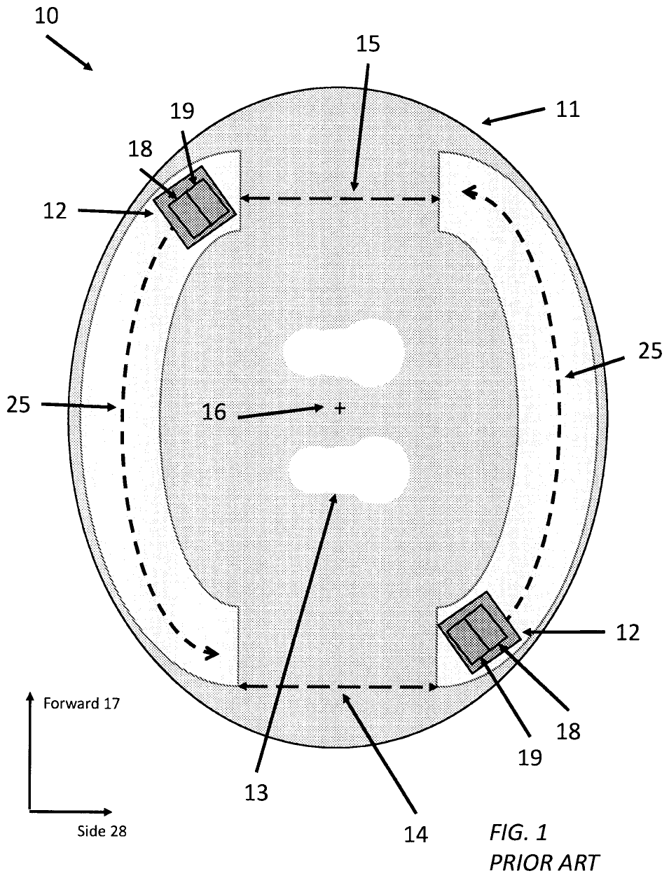

FIG. 1 illustrates a top-view of a prior art system 10 for imaging an individual according to conventional concepts. The individual enters the imaging chamber 11 in a forward direction 17 through the entrance 14 and stands at or about a central point 16 in the chamber. The central point 16 can be indicated using instructional markings 13 to aid the individual in understanding how to stand for purposes of scanning such as footprint markings. The individual turns in a direction orthogonal to an axis that connects the entrance 14 and an exit 15 of the chamber 11. In other words, the individual turns 90°, often to the right, to face a side direction 28. The individual places his or her hands over his or her head. Once the individual is in the scanning position, two imaging masts 12 rotate around the individual on scan paths 25 as indicated by the arrows in FIG. 1.

Conventionally, the imaging masts 12 are connected in a “tuning fork” shaped configuration to a rigid central mount located in a roof of the chamber 11. Because the two imaging masts 12 are rigidly connected, they both rotate in a same direction, e.g., clockwise or counter-clockwise, and maintain a constant spacing distance between them. The imaging masts include both transmitters 18 and receivers 19. Each receiver 19 is spatially associated with a transmitter 18 such as by being placed in close proximity so as to form or act as a single point transmitter/receiver. In operation, the transmitters 18 sequentially transmit electromagnetic radiation one at a time that is reflected or scattered from the individual, and the reflected or scattered electromagnetic radiation is received by two of the respective receivers 19. A computing device receives signals from the receivers 19 and reconstructs an image of the individual using a monostatic reconstruction technique. Hidden objects or contraband may be visible on the image because the density or other material properties of the hidden object differ from organic tissue and create different scattering or reflection properties that are visible as contrasting features or areas on an image.

The system 10 has several drawbacks. Because each receiver 19 is associated to one transmitter 18, the signal level captured by any one receiver 19 can be low or can be swamped by noise if the masts are distant from the object to be imaged. As a result, a width of the entrance 14 and a width of the exit 15 in the conventional design of system 10 are both small, for example, between 24 and 29 inches wide and may not comfortably accommodate larger individuals or individuals with mobility-assist devices such as wheelchairs. Additionally, the use of a roof for attachment of the masts to the rigid “tuning fork” central mount structure can be a hindrance to tall individuals or for individuals wearing hats or other headgear. Furthermore, the geometry of the system 10 requires the individual to turn 90° to face a side direction 28 before scanning can commence, which requires instruction to and compliance by the individual and can delay scanning while the individual becomes situated correctly. The system 10 also does not employ other detection or scanning modalities such as metal detection or shoe scanning. The system 10 also may not adequately image portions of the individual at the extremes of the mast such as headwear or shoes.

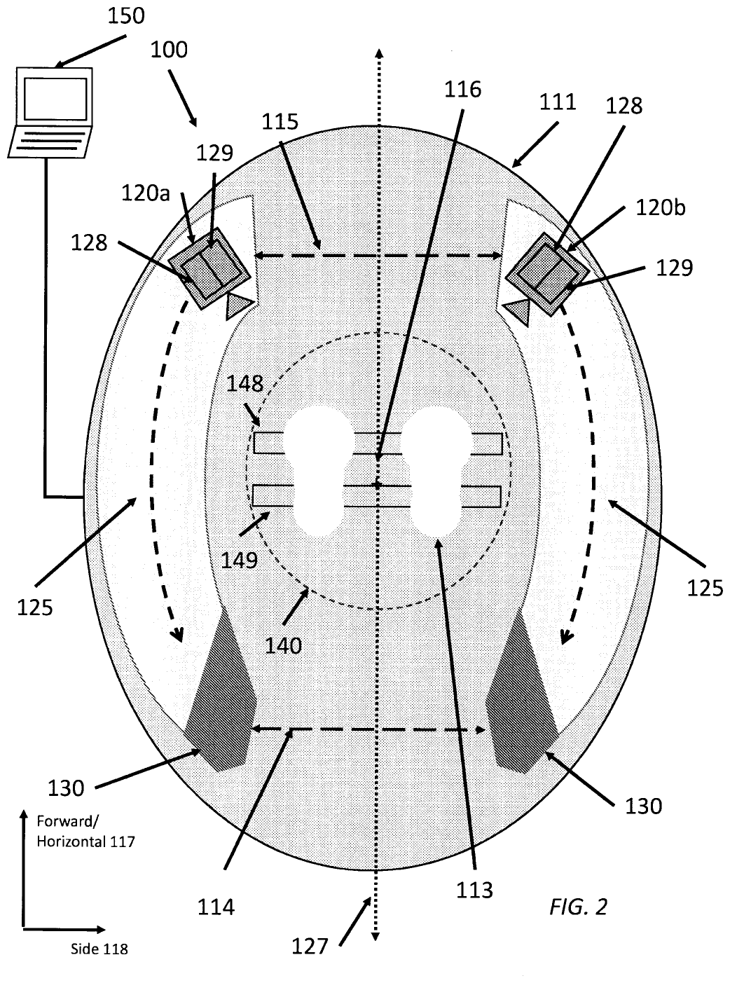

Systems and methods described herein overcome some or all of the disadvantages of system 10 by using imaging masts that move in unison past the individual in a mirror-image fashion along a common horizontal direction (front to back or back to front (i.e., the masts move in unison in a common horizontal direction from entrance to egress or from egress to entrance)) without having the individual rotate 90° upon entering the system. By transmitting and receiving electromagnetic radiation during mirror-image arcuate or linear motion past the individual, the masts can employ multistatic reconstruction methodologies to image an individual that is posed in a forward-facing direction 117. FIG. 2 schematically illustrates a top view of a millimeter-wave system 100 for scanning an individual posed in a forward-facing direction in accordance with some embodiments described herein. The system 100 includes a chamber 111 having an entrance 114 and an exit 115. The system 100 includes one or more imaging masts 120a, 120b. In some embodiments, the system 100 includes a non-invasive walk-through metal detector 130. In some embodiments, the system 100 includes a floor imaging unit 140. The system 100 can include instructional markings 113 such as footprint markings near a central point 116 of the system 100.

Operation of the system 100 produces a greater amount of quality data for image reconstruction as compared to conventional systems 10. Because of the geometry of the imaging masts 120a, 120b and because the number of transmit and receive elements that are active at any one time is increased, the system 100 can receive sufficient data to reconstruct images even with increased spacing between the masts 120 and the individual being imaged. As such, the system 100 can have an ingress and egress width that accommodates a wheelchair or a walker or other assistance device. The increase in the width of the ingress and the egress of the system 100 accommodates a greater variety of individuals, but also provides beneficial advantages over the conventional systems with smaller ingress and egress widths. In some embodiments, the system 100 also utilizes transmitting or receiving antenna elements that compensate for circular polarization to improve data quality and enable sufficient data acquisition to reconstruct images even with the greater spacing between the masts and the individual being imaged.

In accordance with the teachings herein, the individual enters the chamber 111 through the entrance 114 and stands in a forward-facing direction 117 at or around the instructional markings 113. The individual can stand with his/her arms by his/her side. The individual pauses momentarily while the imaging masts 120a, 120b move in unison in a common horizontal direction from either the entrance to the egress or vice versa over respective scan paths past the individual. The path the imaging masts 120a, 120b follow may be linear paths in a common horizontal direction from the entrance to the egress or vice versa or may be arcuate paths in a common horizontal direction from the entrance to the egress or vice versa. The imaging masts 120a, 120b are oriented in a mirror image arrangement. Transmitters 128 on the imaging mast transmit electromagnetic radiation, such as millimeter wave radiation, towards the individual. The radiation reflects or scatters off of the individual and is received by receivers 129 located on the imaging masts 120a, 120b. The receivers 129 send received signal data to a computing device 150 that applies a reconstruction algorithm to the received signal data to reconstruct an image of at least a portion of the individual or an object associated with the individual. Additionally, in some embodiments, transmitters in the floor imaging unit 140 can transmit electromagnetic radiation upwards from the floor towards the individual. The electromagnetic radiation from below reflects or scatters from the individual and is received by receivers in the floor imaging unit 140. The geometry and mirror-image motion of the imaging masts combined with advances in signal processing described in greater detail herein below enables improved image quality and improved user experience in that the user can remain facing forward with hands by their side or on their hips throughout the imaging process rather than turning to face a side direction 118 and placing hands over head. In some embodiments, the system 100 can scan an individual and provide an image to a user in less than six seconds. In some embodiments, the system 100 can enable scanning and imaging of at least 600 individuals per hour. The ability of the individual to keep his/her hands by his/her side during imaging is due in part to the positioning and movement of the masts 120a, 120b to allow mirror imaging therebetween. By comparison, masts in conventional systems are consistently out of phase by 180°, which mostly eliminates use of reflected energy between masts.

As used herein, reference number 120 is used to refer to any imaging mast while specific imaging masts within a particular system embodiment are referred to using reference number 120 followed by a letter (e.g., first imaging mast 120a). The imaging masts 120a, 120b sweep radiation transmission and reception along respective scan paths 125 in a mirror image configuration on opposite (e.g., first and second) sides of the forward-facing individual at the central point 116. For example, a first imaging mast 120a can sweep transmission and reception of radiation over a first scan path 125 on a left side of the central point 116 while a second imaging mast 120b can sweep emission and transmission of electromagnetic radiation over a second scan path 125 on a right side of the central point 116 that is a mirror image of the first scan path 125 across a central horizontal axis 127. In some embodiments, the imaging masts 120a, 120b physically traverse the scan path 125 as with the embodiment of FIG. 2. The physical scan paths can be arcuate or linear in nature. In some embodiments, as mentioned above, the first imaging mast 120a and the second imaging mast 120b move in unison in a common horizontal direction relative to the central horizontal axis 127. For example, the central horizontal axis 127 can be aligned with the forward direction 117. The central horizontal axis 127 can pass through the central point 116. In some embodiments, the central horizontal axis 127 can be defined by an aspect of the object to be imaged, e.g., defined by a median or mid-sagittal anatomical plane of an individual. The first imaging mast 120a passes on a first side of the object to be imaged and the second imaging mast 120b passes on a second side of the object to be imaged. For scan paths with curvature, the direction of rotation of the first mast 120a along its scan path 125 (e.g., counter-clockwise from the point of view of the central point 116) is opposite the direction of motion of the second imaging mast 120b along its arcuate scan path 125 (e.g., clockwise from the point of view of the central point 116). This opposite rotation results in imaging masts 120 on different sides of the central point 116 traveling in a common horizontal direction and differs from conventional systems where rotation of the masts is in the same direction (i.e., clockwise or counterclockwise) from the point of view of the central point 116.

Described yet another way, the imaging masts 120a, 120b can move in unison in a common horizontal direction with respect to the entrance 114 and exit 115 of the chamber 111, i.e., both masts 120a, 120b can move on scan paths 125 having starting positions proximate to the entrance 114 and ending positions proximate to the exit 115 or scan paths 125 having starting positions proximate to the exit 115 and ending positions proximate to the entrance 114. In some embodiments, the common directionality of the scan paths is reversed for each scan operation. In other words, the imaging masts 120a, 120b can travel in a direction from entrance-to-exit for one scan and can travel in the reverse direction from exit-to-entrance during a subsequent scan. In some embodiments, the scan paths 125 for the masts 120a, 120b are configured such that the masts 120a, 120b start at a first spacing distance from one another at the starting position of the scan path. As the masts 120a, 120b travel on the scan path, they move away from one another to reach a second spacing distance away from one another that is greater than the first spacing distance. When the masts 120a, 120b reach the ending position of the scan path, they are spaced apart by a third spacing distance that is less than the second spacing distance. In some embodiments, the sweep of the first imaging mast 120a over the first scan path 125 and the sweep of the second imaging mast 120b over the second scan path 125 occur simultaneously. In some embodiments, the timing of the sweep of the first imaging mast 120a over the first scan path 125 and the timing of the sweep of the second imaging mast 120b over the second scan path 125 occurs in a staggered or offset manner. In some embodiments, the scan paths 125 for the masts 120a, 120b are configured such that the masts 120a, 120b start at a first spacing distance from one another at the starting position of the scan path and substantially maintain the spacing distance past the individual. That is, in some embodiments, the masts 120a, 120b maintain parallelism from starting position to ending position.

The use of mirror-image or oppositely-rotating (i.e., one mast moves clockwise while the other mast moves counter clockwise in simultaneous fashion) scan paths 125 in embodiments of the present disclosure enables scattered or reflected electromagnetic radiation that originated from transmitters 128 on a first mast 120a to be received by receivers 129 stationed on a second mast 120b or on the first mast 120a or both. This creates a greater diversity of measured scattering angles in the imaging data set and a greater quantity of imaging data for each emission event. The greater quantity of imaging data and diversity within the imaging data enables production of images with good quality when data is acquired using scan paths 125 that have less linear distance or cover fewer angles than conventional devices as described in greater detail below. The greater quantity of imaging data and diversity within the imaging data also enables production of images with good quality with data acquired from imaging masts 120 that are further from the individual than in conventional systems 1. As a result, the shorter scan path creates a faster scan, thus improving throughput, and enables the user of a larger chamber with larger entrances 114 and exits 115. In some embodiments, a width of the entrance 114 or a width of the exit 115 can be at least 32 inches (about 81.3 centimeters) or can have a value in a range from 32 inches (81.3 cm) to 48 inches (121.9 cm). In some embodiments, the width of the entrance 114 or the width of the exit 115 can comply with minimum or maximum width requirements imposed by ordinance, regulation, or statute such as the Americans with Disabilities Act (ADA).

The imaging masts 120 can be connected to one or more mounts, frameworks, or linkages that are connected to the roof or floor of the chamber 111 in some embodiments. A motor can be operationally coupled to the mount or mounts to enable motion of the mast 120 along the scan path 125. In some embodiments, the motor is connected to the mount or mounts through a gearbox. In an alternative configuration, the masts 120a, 120b can be mounted to rails or slides. In this arrangement, the masts 120a, 120b can translate along the rails or slides to traverse the scan path 125. In embodiments where masts 120 are mounted to rails or slides, the chamber 111 can be designed without a roof as no overhead mounting structure is used to mount and move the masts 120. As a result, individuals who are naturally tall or who are wearing headgear may be more comfortable in using the roofless system as there is no need to crouch and or remove headgear.

As shown in the top view of FIG. 2, the masts 120 can be mounted in a vertical configuration wherein the transmitters 128 and receivers 129 of the masts 120 are stacked atop one another in a direction parallel to the height of the individual (i.e., in a floor-to-ceiling direction). In other embodiments, the masts 120 can be mounted in a horizontal configuration where transmitters 128 and receivers 129 are stacked in a direction parallel to the floor (e.g., roughly parallel to the forward direction 117). In this arrangement, the scan path 125 is oriented vertically (i.e., traveling from above in a downward direction towards the floor of the chamber 111 or traveling from the floor of the chamber 111 upwards). Masts 120 in the horizontal configuration can slide along rails or slides to travel along the scan path.

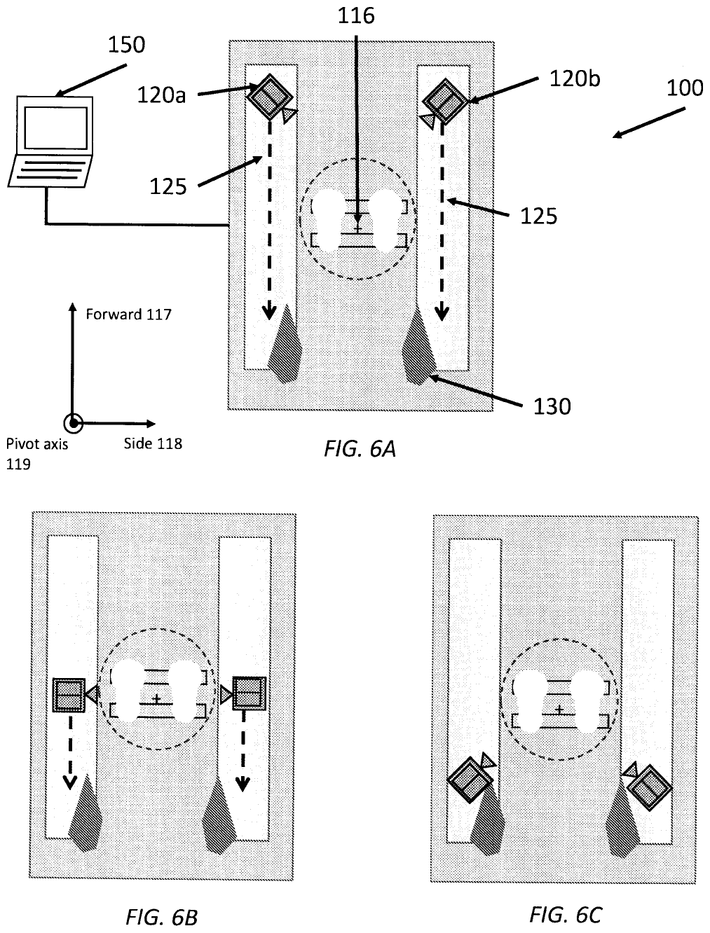

Each imaging mast 120 includes one or more electromagnetic radiation transmitters 128 and one or more electromagnetic radiation receivers 129. In some embodiments, the transmitters 128 and the receivers 129 are organized into self-contained modules that can easily be connected or stacked and are removable or replaceable. Each mast 120 can include between one and two-hundred transmitters and between one and two-hundred receivers. In some embodiments, each mast 120 includes nine modules, and each module includes eight transmitters 128 and twelve receivers 129. A mast 120 suitable for use with systems of the present disclosure is shown in greater detail with respect to FIG. 6. Systems and methods described herein can employ active imaging (i.e., both emission and reception of electromagnetic radiation), passive imaging (i.e., reception of naturally produced or ambient electromagnetic radiation such as blackbody radiation), or both active and passive imaging. In some embodiments, the transmitters 128, the receivers 129, or both transmitters 128 and receivers 129 can compensate for circular polarization.

In some embodiments of the disclosure, the electromagnetic radiation is millimeter wave radiation. In some embodiments, millimeter wave radiation can be used alone or in combination with one or more other forms of electromagnetic radiation such as terahertz radiation, infrared radiation, or others. In some embodiments, the frequency or wavelength of the electromagnetic radiation can be selected based on the penetration depth of electromagnetic radiation at that frequency or wavelength through layers of common organic materials. Millimeter wave refers generally to radiation that has a frequency between approximately 20 and 300 GHz (gigahertz). In one embodiment, the receivers are sensitive to frequencies in a relatively narrow band of the millimeter wave spectrum. In some embodiments, the receivers are sensitive to either one band of frequencies or more than one band of frequencies somewhere in the range between approximately 20 GHz and 300 GHz. In one embodiment, the receivers operate in a band spanning some or all of the frequency spectrum between 90 GHz and 140 GHz. For example, the receivers may be tuned to receive a 94 GHz millimeter wave with an instantaneous bandwidth of approximately 6 GHz, or any receiver may include a plurality of radiometric receivers operating in discrete bands that are each about 6 GHz wide and where each receiver is centered at 3 to 5 discrete center frequencies between 20 and 300 GHz. For example, bands encompassing one or more of the frequencies 35 GHz, 94 GHz, 140 GHz and 220 GHz may be used.

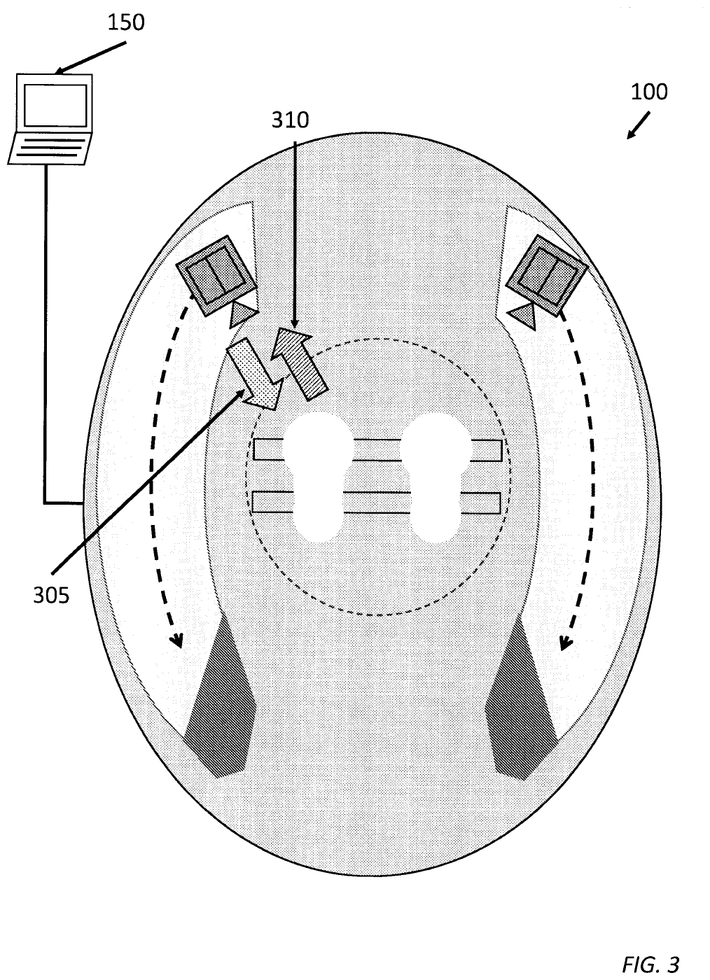

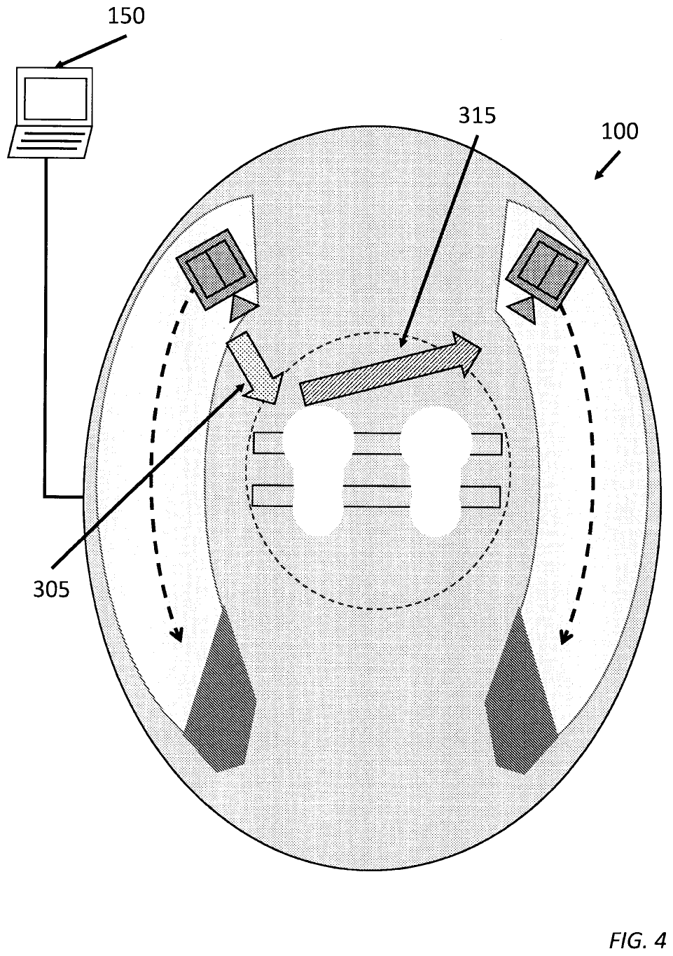

As shown in FIGS. 3 and 4, the transmission and reception of electromagnetic radiation can happen within a same mast or across different masts (sometimes referred to herein as “cross-mast”). FIG. 3 illustrates an imaging modality where the transmitted radiation 305 from transmitters 128 of the first mast 120a is scattered or reflected back 310 to receivers on the first mast 120a. Some embodiments of the present systems and methods include transmission from more than one transmitter at a time. In embodiments with more than one transmitter 128 located on each imaging mast 120, the transmitters 128 on a same mast 120 may transmit radiation sequentially or simultaneously or in selected groups, for example upper 50% of transmitters and lower 50% of transmitters or alternating groups of transmitters by vertical position on the mast. In some embodiments, all transmitters 128 on a same mast 120 can transmit simultaneously. In some embodiments, all transmitters 128 on both masts 120 can transmit radiation simultaneously. Radiation emitted from the multiple transmitters 128 can be detected by multiple receivers 129. The number of transmitters 128 and receivers 129 involved in time step of an imaging operation (e.g., a point in time as the masts move) is factorial. In some embodiments, an encoding scheme can be used such that the radiation received at a particular receiver 129 can be associated to a respective transmitter 128 based upon the encoding scheme. For example, each transmitter 128 can transmit electromagnetic radiation having a signature, such as a frequency signature, amplitude signature, or phase signature, or electromagnetic radiation that is modulated in a unique way. In some embodiments, the computing device 150 can control the number of transmitters 128 and the number of receivers 129 used in an imaging operation based upon the desired range of sizes of objects to be imaged or the desired throughput. The computing device 150 can receive the parameters related to the desired range of sizes of object or the desired throughput from a user (e.g., through a graphical user interface) or based upon a set of rules that can include location of the system and factors such as time of day or detected slowdowns. In some environments, smaller objects are desired to be imaged (e.g., detection of objects such as memory cards at the exit to a secure facility), and more transmitters 128 and receivers 129 can be used to improve resolution. In some environments, high throughput is desired and fewer transmitters 128 and receivers 129 can be used to reduce computational overhead.

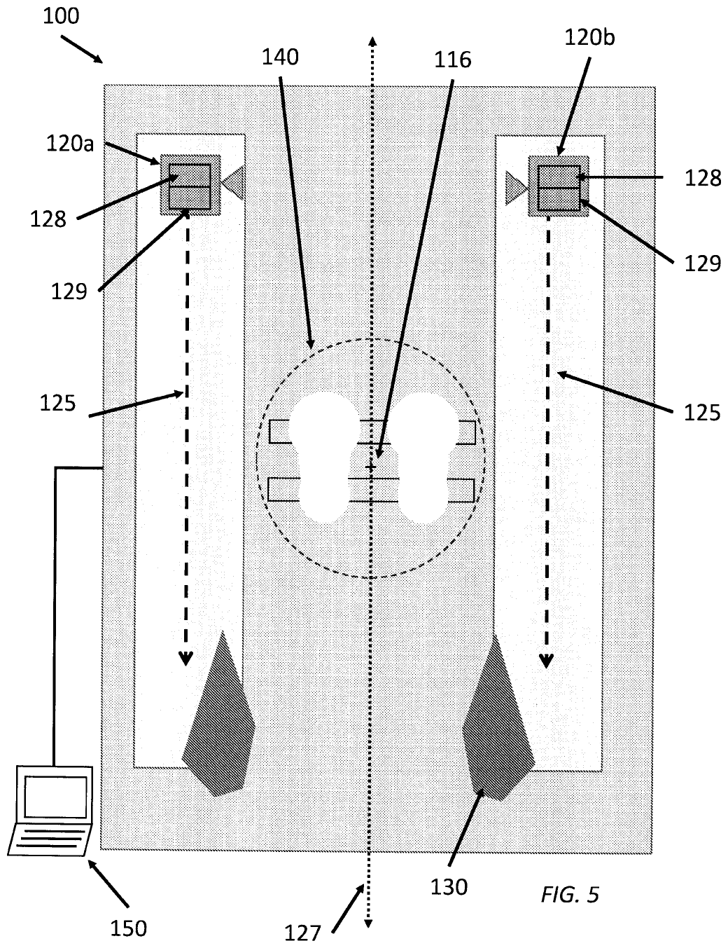

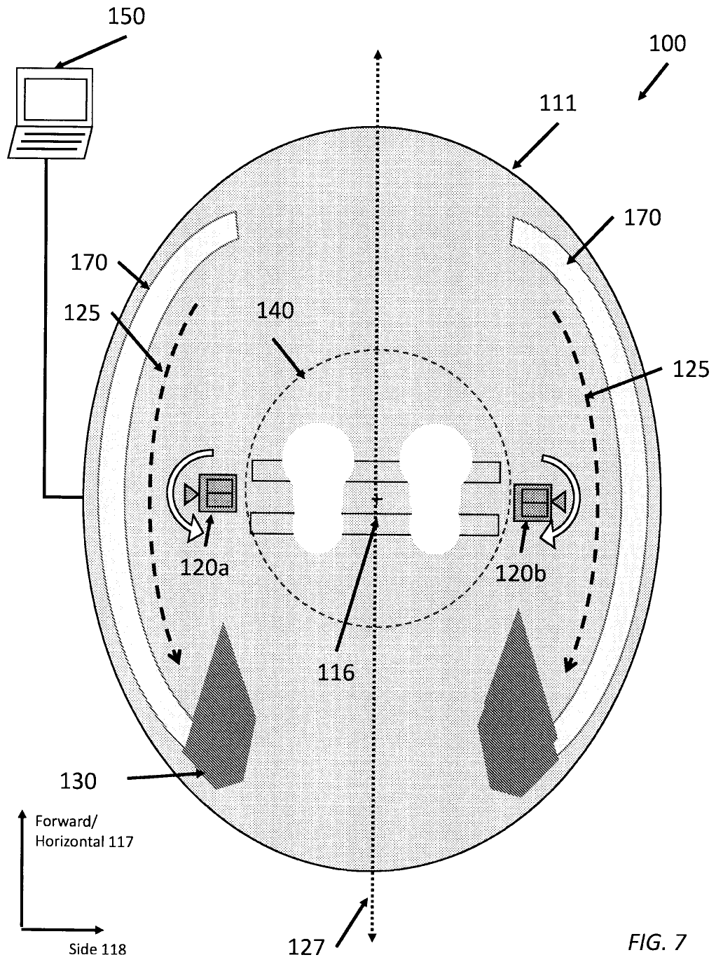

In various embodiments, the computing system 150 can apply a monostatic reconstruction algorithm, a multistatic reconstruction algorithm, or both algorithms to data received by one or more receivers 129. To employ a monostatic reconstruction algorithm, the computing system receives imaging data from the receiver 129 that is associated with the actively-transmitting transmitter 128. The monostatic reconstruction algorithm takes advantage of significant computational simplicity using a point-source approximation that approximates the transmission and reception locations as a single point. In some embodiments of the present disclosure, the computing device can receive imaging data from distant (i.e., non-collocated or non-associated) receivers 129 that are too distant to allow for use of a point-source approximation. In some embodiments, the computing device 150 receives imaging data from more than one receiver 129 or from all receivers 129 on the same imaging mast 120a during emission of radiation by a single transmitter 128. The transmission and reception sequence continues for each transmitter on the imaging mast 120a. Then, the computing device 150 controls the imaging mast 120a to advance the emission azimuthally or linearly along the scan path 125 and the transmission/reception sequence starts again. Advancement azimuthally or linearly can mean physical translation of the imaging mast 120 as with the embodiments of FIGS. 2 and 5 or tilting or pivoting of the imaging mast 120 to aim at a different position on the reflector 170 as with the embodiment of FIG. 7. The use of imaging data from receivers that are distant enough to be poorly approximated as being located at the same “point” as the transmitter enables the use of multi-static reconstruction techniques. For example, use of multiple receivers receiving while a single transmitter transmits forms a multi-static system. A multi-static system can be used to form a set of bi-static images. The multiple bi-static images can be coherently or incoherently combined to form a three-dimensional reconstruction of the imaged scene.

FIG. 4 illustrates an imaging modality where the transmitted radiation 305 from the first mast 120a is scattered or reflected 315 to receivers on the second mast 120b. The computing device can receive imaging data from one receiver 129, multiple receivers 129, or all receivers 129 on the second mast 120b corresponding to emission of radiation from the transmitter on the first imaging mast 120a.

In some embodiments, the transmitters on the first mast 120a transmit radiation at a first time step. The reflected or scattered radiation is received by receivers on both the first mast 120a and the second mast 120b. At a subsequent time step (i.e., after the masts 120a, 120b have moved by a specified azimuthal or linear distance), the transmitters on the first mast 120a stop transmitting and the transmitters on the second mast 120b begin transmitting radiation. The reflected or scattered radiation that originated from the second mast 120b is received by receivers on both the first mast 120a and the second mast 120b. The geometry of the system 100 allows that any given receiver 129 may receive scattered or reflected radiation originating from a number of transmitters 128 on both the same mast and cross-mast. In some embodiments, the number of possible combinations of active transmitters and active receivers at a given time step is factorial.

The mirror-image scan paths 125 of the present disclosure enables the use of cross-mast detection as shown in FIG. 4. In conventional systems such as system 10 of FIG. 1, the two imaging masts 12 orbit around the individual in the same rotational direction at a fixed distance. The location of the individual at the central point 16 means that the individual blocks the majority of the electromagnetic radiation that is transmitted by transmitters 18 in the mast 12. The shielding of the electromagnetic radiation by the individual means that little to no reflected or scattered signal can reach receivers on the oppositely positioned imaging mast 12.

In some embodiments, the computing device 150 can obtain information about the relative locations of the transmitter 128 and each receiver 129 at a given time during the imaging sweep over the scan path 125. For example, this information can be retrieved by the computing device 150 from encoders attached to each imaging mast 120 that identify absolute position of the imaging mast 120. As another example, the computing device 150 can control motion of the imaging mast 120 and can estimate position or location based on a calibration curve that relates the value of an output signal from the computing device 150 (e.g., a voltage) to the position of the imaging mast 120. In some embodiments, the computing device 150 can filter imaging data that is acquired during a time when the first imaging mast 120a and the second imaging mast 120b are substantially opposite from one another. The filtering can separate scattered radiation from the individual from directly received radiation that traveled directly from the transmitter of one imaging mast 120a to the receiver on another imaging mast 120b when they are directly opposite.

In some embodiments, the scan path 125 of the masts 120 can be shorter (e.g., can cover fewer angles or less linear distance) than scan paths of receivers in conventional systems. Specifically, the additional data throughput provided by systems and methods described herein can enable reconstruction of high-quality images even for data acquired over a smaller set of angles (or distances) than the set of angles (or distances) required in conventional systems. In some embodiments, the length of the scan path can be reduced by a value in a range from 10%-50% as compared to the length of a conventional scan path 25. In some embodiments, the length of the scan path 125 in the present disclosure can be reduced by 33% in comparison to the length of a conventional scan path 25. In some embodiments, the length of the scan path 125 can be in a range between 40 inches (about 100 cm) and 60 inches (about 150 cm).

The system 100 can employ auto-initiation in some embodiments. The imaging masts 120 can be used as “radar” units to detect the distance between the individual and the central point 116. In some embodiments, the transmitters 128 from one or both imaging masts 120a, 120b can begin transmitting radiation while the individual is entering the chamber 111 and steps toward the central point 116. The computing device 150 can then receive imaging data from receivers 129 on one or both imaging masts 120a, 120b before the individual has come to rest at the central point 116. In some embodiments, the transmitters 128 from one or both imaging masts 120a, 120b can begin transmitting radiation once the individual has entered the chamber 111 and is standing at the central point 116. The computing device 150 can then receive imaging data from receivers 129 on one or both imaging masts 120a, 120b before the individual has come to rest at the central point 116. The computing device 150 can process the imaging data to determine a position of the individual with respect to the imaging masts 120 or the central point 116. In some embodiments, the computing device 150 can identify when the individual has come to rest at the central point 116 and can automatically initiate a scan or prompt the operator of the system to initiate the scan. In some embodiments, the computing device 150 can adjust an x-y position of the floor imaging unit 140 based upon the detected location of the individual within the chamber 111.

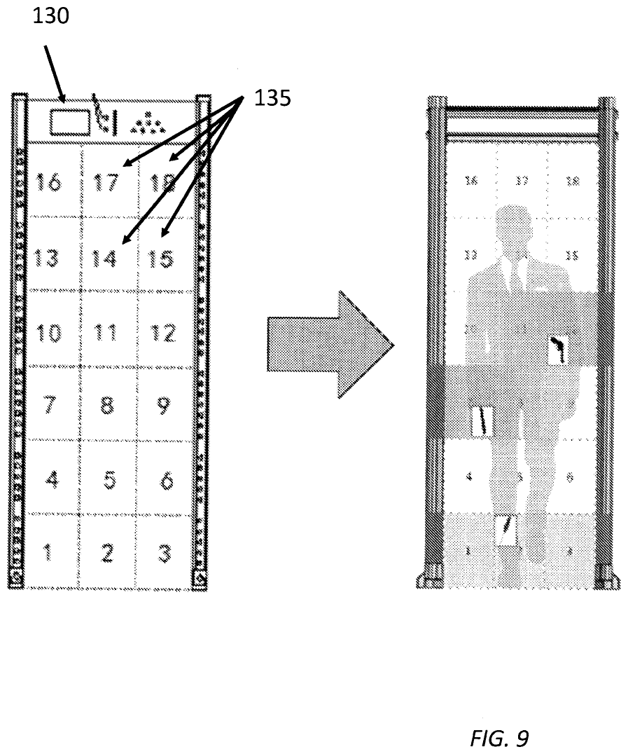

Returning to FIG. 2, the non-invasive walk-through metal detector 130 can detect the presence of metal or metallic objects on the individual's person as the individual walks through the metal detector 130. In some embodiments, the non-invasive walk-through metal detector 130 has an arch or doorway shape. The non-invasive walk-through metal detector 130 can frame the entrance 114 of the chamber 111 such that the individual must pass through the metal detector 130 to enter the chamber 111. In conventional security floorplans and layouts such as security screening areas at airports, millimeter-wave scanning and metal detection are often provided as side-by-side alternatives wherein individuals pass through one device or the other device. Such a side-by-side setup reduces overall detection efficiency as only one detection modality is used for each individual. To accomplish both metal detection and millimeter-wave scanning, the individual has to pass through one device, return to the entrance, and pass through the second device, which slows throughput of the system. By combining the non-invasive walk-through metal detector 130 with electromagnetic radiation scanning (e.g., millimeter wave scanning) in a single system 200, both detection modalities can be used on an individual in a single pass, thereby increasing throughput and overall detection efficacy. Data from the metal detector 130 can also be combined with imaging data from the imaging masts 120 to improve the quality of the final image. Additional detail regarding the non-invasive walk-through metal detector 130 is provided below with respect to FIG. 9.

The chamber 111 can include material that is absorbent or transparent to the electromagnetic radiation transmitted from the transmitters 129, 149 (e.g., millimeter-wave or radar signals).

The floor imaging unit 140 is located on or below a floor of the chamber 111 that supports the individual. The floor imaging unit 140 includes one or more electromagnetic radiation transmitters 148 and one or more receivers 149. The transmitters 148 transmit electromagnetic radiation upwards towards the feet of the individual. Scattered or reflected radiation from the individual is received by the receivers 149. In some embodiments, one or more of the transmitters in the floor imaging unit 140 are attached to an x-y gantry that moves one or more of the transmitters 148 in an x-y direction under the feet of an individual. In some embodiments, one or more of the transmitters and one or more receivers in the floor imaging unit 140 are attached to an x-y gantry that moves the one or more of the transmitters 148 and the one or more receivers 149 in an x-y direction under the feet of an individual. The receivers 149 send imaging data to the computing device 150, which can apply a reconstruction algorithm to the imaging data to reconstruct an image of at least a shoe portion of the individual. In some embodiments, the computing device 150 can apply the reconstruction algorithm to both imaging data from the floor imaging unit 140 and imaging data from one or more imaging masts 120 to create the image of the portion of the individual. In some embodiments, the receivers in the masts 120a, 120b are active during operation of the floor imaging unit 140. In some embodiments, the transmitters in the masts 120a, 120b are active during operation of the floor imaging unit 140. In some embodiments, the transmitters 128 in the masts 120a, 120b and the receivers 129 in the masts 120a, 120b are active during operation of the floor imaging unit 140. In this manner, imaging from the masts and the floor imaging unit maybe combined or otherwise used to image and evaluate the shoes of an individual.

In a conventional security floorplan or layout, the individual often removes footwear while passing through the system 10 so that the footwear can be separately scanned for contraband using complementary luggage/baggage/package scanning systems, e.g., systems employing x-ray imaging. The removal and reapplication of footwear by the individual results in significant delays, a negative user experience, and additional burdens and delays on complementary luggage/baggage/package scanning systems that must scan the footwear. The floor imaging unit 140 of the present disclosure improves scanning throughput and user satisfaction by performing scanning of the footwear while the footwear is still being worn by the individual. In some embodiments, the floor imaging unit 140 can perform scanning of the footwear simultaneously with the performance of other scanning or imaging of the individual such as during the scanning sweep of the imaging masts 120. In some embodiments, the transmitters of the floor imaging unit 140 transmit millimeter-wave radiation. In some embodiments, the transmitters of the floor imaging unit 140 transmit infrared radiation.

FIG. 5 illustrates an embodiment of the system 100 wherein the imaging masts 120a, 120b undergo motion on a linear scan path 125 rather than an arcuate scan path 125. As mentioned previously, the imaging masts 120a, 120b can be mounted on slides or rails that enable the masts to translate along the scan path 125 during data acquisition.

FIGS. 6A-6C illustrate steps in a motion sequence for an embodiment of the system 100 wherein the imaging masts 120a, 120b undergo motion on a linear scan path 125 while simultaneously pivoting about a pivot axis 119 perpendicular to a direction of the scan path 125 (e.g., perpendicular to the forward direction 117). Pivoting the imaging masts 120a, 120b during motion along the scan path 125 can ensure that the transmitters 128 are aiming towards the central point 116. In this way, the amount of radiation that reaches (and is scattered or reflected by) the individual is increased. In some embodiments, the pivot axis 119 can pass through the imaging masts 120. For example, each mast 120 can be mounted to pivots at a top and a bottom of the mast. In other embodiments, the pivot axis 119 can pass outside the imaging masts 120. For example, the mast 120 can be connected to pivots at a rear panel of the mast. In some embodiments, beam steering techniques maybe used in place of mechanical devices that may be used to rotate, pivot or tilt the masts 120a, 120b as they move in unison in a common horizontal direction. In some embodiments, individual receivers or transmitters or both are beam steered. In some embodiments, groups of receivers or transmitters (e.g., modules) or both are beam steered. In some embodiments, all receivers or all transmitters or both are beam steered. Beam steering advantageously focuses energy on the individual in some dynamically set optimized way to maximize some attribute (such as items that pop out on a first pass in a multiple pass protocol) or if one wishes to tune the system to concentrate on certain areas where people try to hide things, for example, under hats, groin, so on.

FIG. 7 illustrates an embodiment of the system 100 wherein the transmitters 128 of the imaging masts 120a, 120b transmit radiation towards a reflector 170. The reflector 170 redirects the transmitted radiation towards the central point 116. Radiation that is emitted or scattered from the individual arrives at the reflector 170 and is redirected towards receivers 129 on the imaging masts 120a, 120b. In this arrangement, the imaging masts 120a, 120b can rotate in place to transmit and receive radiation along the full extent of the reflector 170. As such, the scan path 125 is virtual as the transmitted radiation is directed towards the central point 116 from a collection of points along the surface of the reflector 170 and returning radiation is received from the collection of points along the surface of the reflector 170.

In some embodiments, the imaging masts 120a, 120b do not physically rotate. Rather, electronic beam steering is used to change the directionality of the transmission and reception with respect to the reflector 170. In some embodiments of the system 100, the imaging masts 120a, 120b remain stationary and the reflector 170 rotates, translates, or pivots to direct transmission or reception of electromagnetic radiation to different areas within the chamber 111. In some embodiments, the reflector 170 can be a portion of a reflective system that for an adjustable optical path between the imaging mast 120a, 120b and the individual to be scanned.

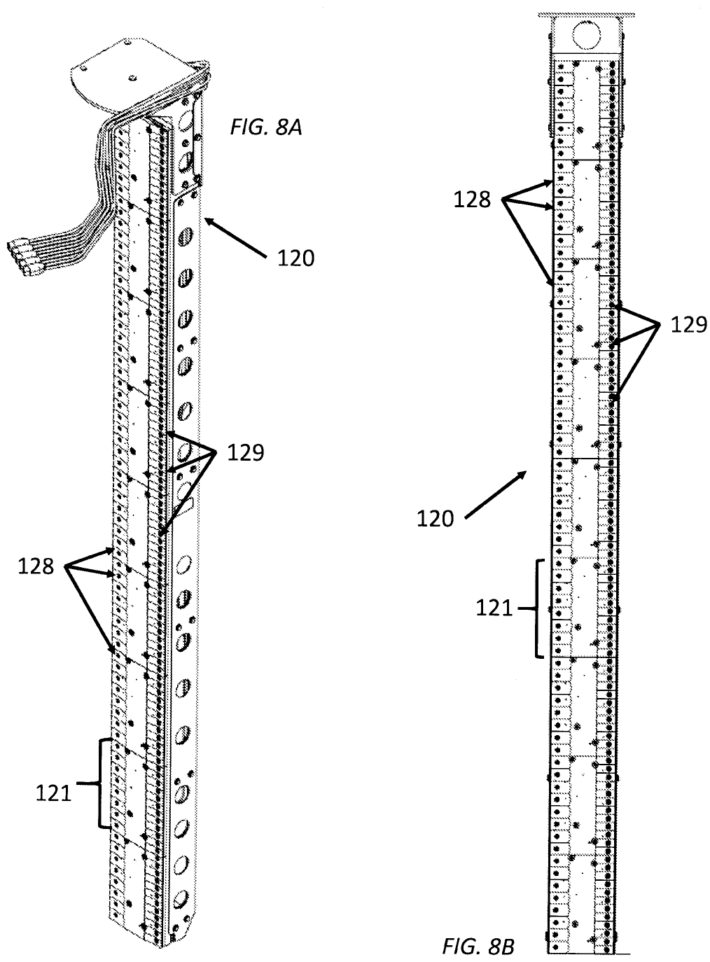

FIGS. 8A and 8B illustrate perspective and front views of an imaging mast 120 for use with some embodiments of systems and methods of the present disclosure. As mentioned previously, the imaging mast 120 can be made up of stacked or adjacent or non-adjacent modules 121 that each contain one or more transmitters 128 and one or more receivers 129. The modules 121 can be removable or replaceable. In the imaging mast 120 depicted in FIGS. 8A and 8B, each imaging mast includes nine modules 121. However, it should be understood that the imaging mast 120 can include any number of modules 121 or can be constructed using discrete transmitters, receivers, and other mechanical or electronic components that are assembled as modules in various embodiments. Each module 121 depicted in FIGS. 8A and 8B includes eight transmitters 128 and twelve receivers 129. However, it should be understood that each module 121 or, indeed, each imaging mast can include any suitable number of transmitters 128 and receivers 129 that are desired to achieve a given final image resolution.

FIG. 9 schematically illustrates a front-view of the non-invasive walk-through metal detector 130 in accordance with some embodiments described herein. The non-invasive walk-through metal detector 130 can detect the presence of metal or metallic objects being carried on the person of the individual as the individual passes through the non-invasive walk-through metal detector. In some embodiments, the non-invasive walk-through metal detector can localize the detected presence of the metal object to one or more spatial detection zones 135 in a volume of space through which the individual passes. For example, the metal detector 130 can use multiple pulse induction coils to generate localized magnetic fields that are disrupted or affected by the presence of metal objects. By ascertaining the impact on the magnetic fields of each of the coils, the metal object can be localized to a particular spatial detection zone 135. The volume of space measured by the non-invasive walk-through metal detector can include the entrance 114 of the chamber 111 or the exit 115 of the chamber 111 in various embodiments.

The computing device 150 can receive data from the non-invasive walk-through metal detector identifying the spatial detection zones where a metal object has been detected. The computing device 150 can use this information during execution of the reconstruction algorithm to generate the image of the portion of the individual. For example, if the non-invasive walk-through metal detector 130 detects an object in the spatial detection zone corresponding to a position at the individual's right hip (e.g., a certain distance from the floor on the right hand side of the individual), the computing device 150 can use a finer reconstruction mesh during reconstruction of the spatial volume including the individual using imaging data from the imaging masts 120. Alternatively, the computing device 150 may control the imaging masts 120 to sweep more slowly through the portion of the scan path corresponding to the spatial volume that includes the individual's right hip. In some embodiments, the computing device 150 may control the imaging masts 120 to perform multiple transmission/reception cycles using the transmitters 128 that most fully irradiate the individual's right hip (e.g., the transmitter 128 located at approximately hip-height along the length of the imaging mast 120b). In some embodiments, the non-invasive walk-through metal detector 130 can be selectively disabled to allow individuals having contra-indicated medical conditions to pass through the metal detector 130. In some embodiments, the non-invasive walk-through metal detector 130 can be selectively used as a pre-screening device allowing an operator to instruct an individual to step back or out of the line rather than step in.

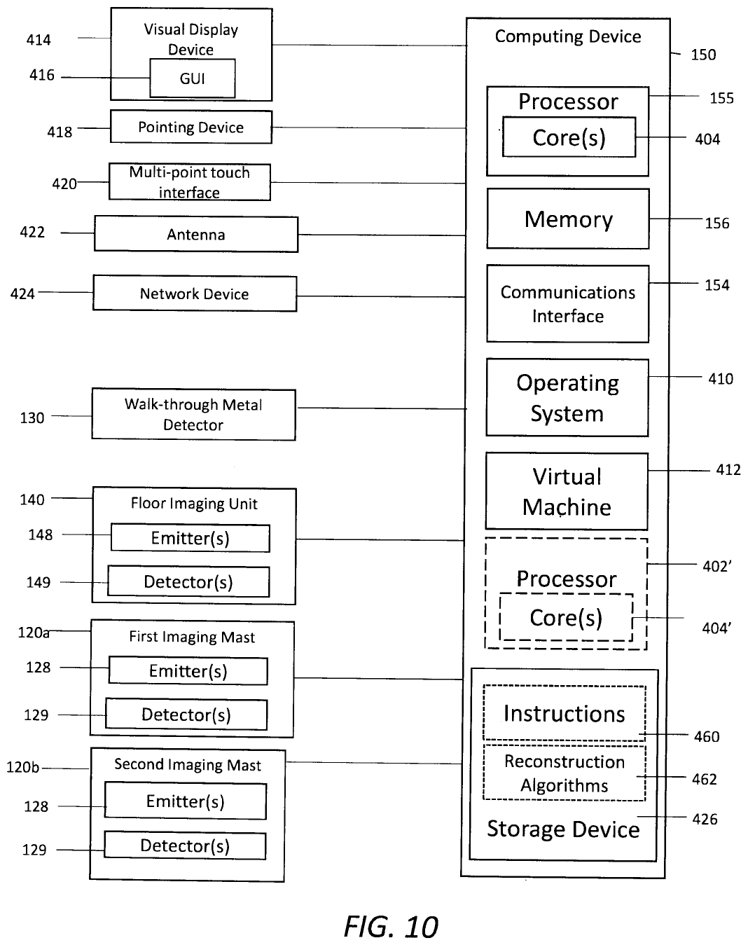

FIG. 10 is a block diagram of a computing device 150 suitable for use with embodiments of the present disclosure. The computing device 150 may be, but is not limited to, a smartphone, laptop, tablet, desktop computer, server, or network appliance. The computing device 150 includes one or more non-transitory computer-readable media for storing one or more computer-executable instructions or software for implementing the various embodiments taught herein. The non-transitory computer-readable media may include, but are not limited to, one or more types of hardware memory (e.g., memory 156), non-transitory tangible media (for example, storage device 426, one or more magnetic storage disks, one or more optical disks, one or more flash drives, one or more solid state disks), and the like. For example, memory 156 included in the computing device 150 may store computer-readable and computer-executable instructions 460 or software (e.g., instructions to receive data from receivers 129 of the imaging masts 120, data from receivers 149 of the floor imaging unit 140, or data from the non-invasive walk-through metal detector 130; instructions to perform image reconstruction methods using monostatic or multistatic reconstruction algorithms 462; etc.) for implementing operations of the computing device 150. The computing device 150 also includes configurable and/or programmable processor 155 and associated core(s) 404, and optionally, one or more additional configurable and/or programmable processor(s) 402′ and associated core(s) 404′ (for example, in the case of computer systems having multiple processors/cores), for executing computer-readable and computer-executable instructions or software stored in the memory 156 and other programs for implementing embodiments of the present disclosure. Processor 155 and processor(s) 402′ may each be a single core processor or multiple core (404 and 404′) processor. Either or both of processor 155 and processor(s) 402′ may be configured to execute one or more of the instructions described in connection with computing device 150.

Virtualization may be employed in the computing device 150 so that infrastructure and resources in the computing device 150 may be shared dynamically. A virtual machine 412 may be provided to handle a process running on multiple processors so that the process appears to be using only one computing resource rather than multiple computing resources. Multiple virtual machines may also be used with one processor.

Memory 156 may include a computer system memory or random access memory, such as DRAM, SRAM, EDO RAM, and the like. Memory 156 may include other types of memory as well, or combinations thereof.

A user may interact with the computing device 150 through a visual display device 414, such as a computer monitor, which may display one or more graphical user interfaces 416. The user may interact with the computing device 150 using a multi-point touch interface 420 or a pointing device 418.

The computing device 150 may also include one or more computer storage devices 426, such as a hard-drive, CD-ROM, or other computer readable media, for storing data and computer-readable instructions 460 and/or software that implement exemplary embodiments of the present disclosure (e.g., applications). For example, exemplary storage device 426 can include instructions 460 or software routines to enable data exchange with one or more imaging masts 120a, 120b, the floor imaging unit 140, or the non-invasive walk-through metal detector 130. The storage device 426 can also include reconstruction algorithms 462 that can be applied to imaging data and/or other data to reconstruct images of scanned objects.

The computing device 150 can include a communications interface 154 configured to interface via one or more network devices 424 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 150 can include one or more antennas 422 to facilitate wireless communication (e.g., via the network interface) between the computing device 150 and a network and/or between the computing device 150 and components of the system such as imaging masts 120, floor imager unit 140, or metal detector 130. The communications interface 154 may include a built-in network adapter, network interface card, PCMCIA network card, card bus network adapter, wireless network adapter, USB network adapter, modem or any other device suitable for interfacing the computing device 150 to any type of network capable of communication and performing the operations described herein.

The computing device 150 may run an operating system 410, such as versions of the Microsoft® Windows® operating systems, different releases of the Unix® and Linux® operating systems, versions of the MacOS® for Macintosh computers, embedded operating systems, real-time operating systems, open source operating systems, proprietary operating systems, or other operating system capable of running on the computing device 150 and performing the operations described herein. In exemplary embodiments, the operating system 410 may be run in native mode or emulated mode. In an exemplary embodiment, the operating system 410 may be run on one or more cloud machine instances.

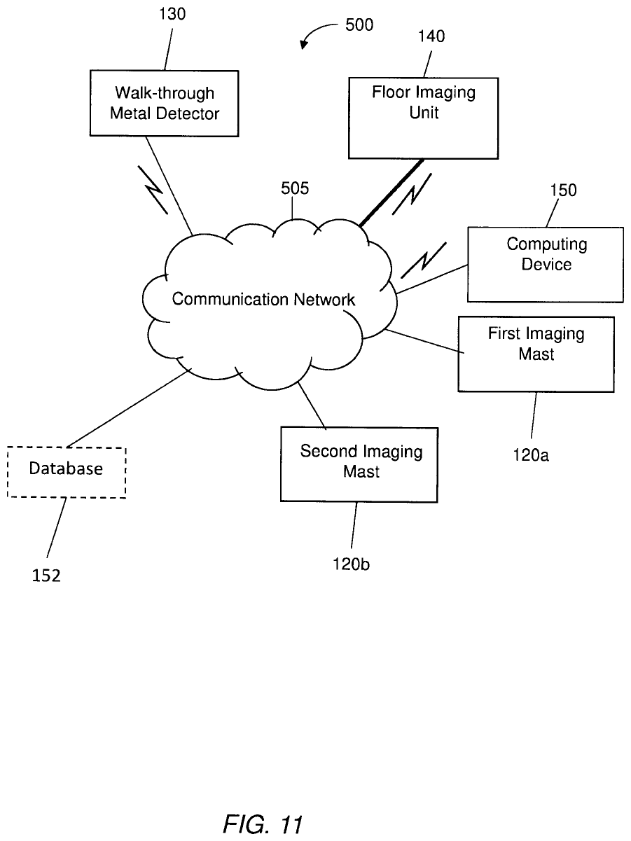

FIG. 11 illustrates a network environment 500 including the computing device 150 and other elements of the systems described herein that is suitable for use with exemplary embodiments. The network environment 500 can include one or more databases 152, one or more imaging masts 120, 120a, 120b, one or more non-invasive walk-through metal receivers 130, one or more floor imaging units 140, and one or more computing devices 150 that can communicate with one another via a communications network 505.

The computing device 150 can host one or more applications (e.g., instructions 460 or software to communicate with or control imaging masts 120, transmitters 128, receivers 129, metal receivers 130, floor imaging units 140, floor transmitters 148, or floor receivers 149 and any mechanical, motive, or electronic systems associated with these system aspects; reconstruction algorithms 462; or graphical user interfaces 416) configured to interact with one or more components of the system 100 and/or to facilitate access to the content of the databases 152. The databases 152 may store information or data including instructions 460 or software, reconstruction algorithms 462, or imaging data as described above. Information from the databases 152 can be retrieved by the computing device 150 through the network 505 during an imaging or scanning operation. The databases 152 can be located at one or more geographically distributed locations away from some or all system components (e.g., imaging masts 120, floor imaging unit 140, metal detector 130) and/or the computing device 150. Alternatively, the databases 152 can be located at the same geographical location as the computing device 150 and/or at the same geographical location as the system components. The computing device 150 can be geographically distant from the chamber 111 or other system components (masts 120, metal detector 130, floor imaging unit 140, etc.). For example, the computing device 150 and operator can be located in a secured room sequestered from the location where the scanning of individuals takes place to alleviate privacy concerns. The computing device 150 can also be located entirely off-site in a remote facility.

In an example embodiment, one or more portions of the communications network 505 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMAX network, an Internet-of-Things (IoT) network established using BlueTooth® or any other protocol, any other type of network, or a combination of two or more such networks.

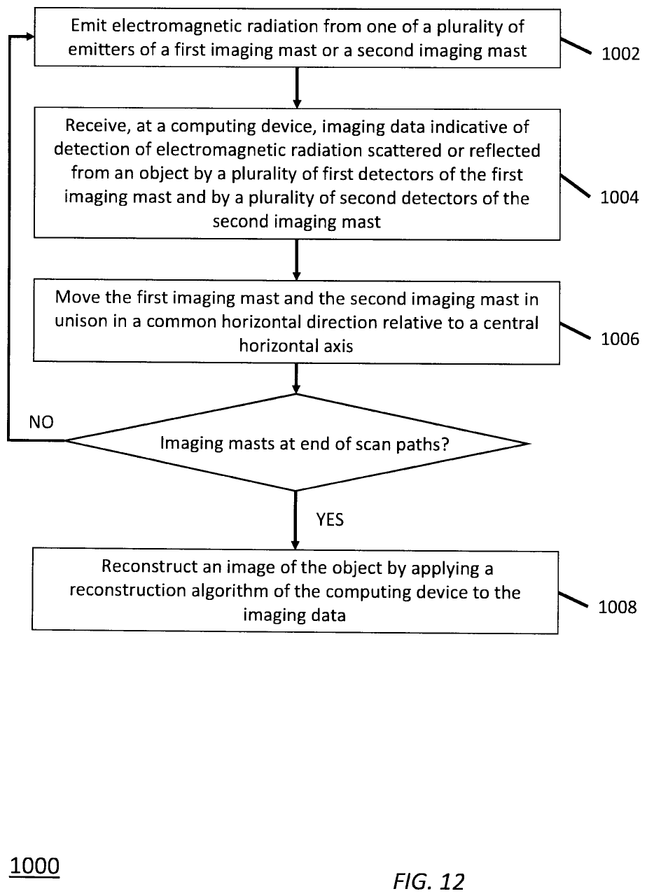

FIG. 12 illustrates a method 1000 to screen an individual by detecting hidden objects that are being carried by the individual using system embodiments of the present disclosure. The method 1000 produces an image of an object wherein the object can include all or a portion of the individual themselves, an object carried by the individual, or both. The method 1000 is applicable for use with any of the embodiments described herein such as those of FIG. 2, 5, or 7. The method 1000 includes transmitting electromagnetic radiation from one of a plurality of transmitters 128 of the first imaging mast 120a or the second imaging mast 120b (step 1002). The method 1000 also includes receiving, at a computing device 150, imaging data indicative of reception of electromagnetic radiation scattered or reflected from the object by a plurality of first receivers 129 of the first imaging mast 120a and by a plurality of second receivers 129 of the second imaging mast 120b (step 1004). The method includes moving the first imaging mast 120a and the second imaging mast 120b in unison in a common horizontal direction relative to a central horizontal axis 127 (step 1006).

Steps 1002, 1004 and 1006 can be repeated until the imaging masts have reached the end of their scan paths 125 to collect sufficient imaging data to enable a three-dimensional image reconstruction. In some embodiments, the emission from the plurality of transmitters can be performed in a sequential manner. For example, the computing device 150 can cause each of the first plurality of transmitters on the first imaging mast 120a to transmit radiation in a specified order (e.g., end to end on the mast, center to edge, or in another alternating sequence). Then, the computing device 150 can cause each of the second plurality of transmitters on the second imaging mast 120b to transmit radiation in a specified order. Once each transmitter in the system has transmitted radiation, the sequence can restart from the beginning as to the two masts continue to move in unison.

Once the imaging masts 120 have reached the end of their scan paths, data acquisition is complete and the image can be reconstructed. The method 1000 includes reconstructing the image of the object by applying a reconstruction algorithm (e.g., a multistatic reconstruction algorithm) of the computing device 150 to the imaging data (step 1008).

In some embodiments, a different step can be substituted for step 1006 wherein the system can utilize a non-translating imaging mast and reflector as in FIG. 7. For example, the replacement step can involve physical rotation of the mast 120 and/or transmitters 128 or the use of electronic beamforming methods to move the location of the primary emission lobe of the transmitters 128 to a different point on the reflector 170 as described above.

The following analysis of the method 1000 in relation to a specific embodiment should not be construed as limiting. The method 1000 can be performed using a system 100 such as that of FIG. 2 utilizing imaging masts 120 similar to that shown in FIGS. 8A-8B. If all nine modules 121 of the imaging masts 120 are used in performance of the method 1000, the first imaging mast 120a produces nine times as much imaging data as would be produced using conventional methods (i.e., single module transmission and reception to enable use of the point-source approximation as described previously). At the same time, modules 121 of the second imaging mast 120b would also produce nine additional sets of imaging data for a total improvement of 18× the imaging data for a single point along the scan paths. The method 1000 alternates emission between transmitters 128 of the first mast 120a at the first position and transmitters 128 of the second mast 120 at the second position whereas the conventional method may fire transmitters from both masts at each position. As a result, the data throughput of the method 1000 is about nine times that of conventional methods. Overall, the method 1000 gathers about six times as much imaging data as compared to conventional systems and methods. The increased amount of imaging data collected per sweep or scan enables the use of shorter scan paths. The increased amount of data is due in part to embodiments in which all transmit and receive elements in the masts 120, 120b are transmitting and receiving at once, as compared to conventional systems where transmitters and receivers are sequentially turned on and off. In embodiments that allow and individual to walk through the system 100 without stopping the method 1000 gathers about sixty two times as much imaging data as compared to conventional systems and methods.

In describing example embodiments, specific terminology is used for the sake of clarity. Additionally, in some instances where a particular example embodiment includes multiple system elements, device components or method steps, those elements, components or steps may be replaced with a single element, component, or step. Likewise, a single element, component, or step may be replaced with multiple elements, components, or steps that serve the same purpose. Moreover, while example embodiments have been illustrated and described with references to particular embodiments thereof, those of ordinary skill in the art will understand that various substitutions and alterations in form and detail may be made therein without departing from the scope of the present disclosure. Further still, other aspects, functions, and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A scanning system, comprising:
a first imaging mast including a first plurality of electromagnetic radiation transmitters and a first plurality of electromagnetic radiation receivers, the first imaging mast configured to move past a first side of an object positioned along a central horizontal axis to image at least a first portion of the object;
a second imaging mast including a second plurality of electromagnetic radiation transmitters and a second plurality of electromagnetic radiation receivers, the second imaging mast configured to move past a second side of the object to image at least a second portion of the object, the first imaging mast and the second imaging mast configured to move in unison in a common horizontal direction relative to the central horizontal axis; and
a computing device including a processing unit, the computing device configured to execute instructions to:
receive imaging data from the first imaging mast, the second imaging mast, or both imaging masts, the imaging data representative of electromagnetic radiation reflected or scattered by the object as the first imaging mast and the second imaging mast move past the object; and
apply a reconstruction algorithm to the imaging data to produce an image of at least a portion of the object.

2. The scanning system of claim 1, wherein movement of the first imaging mast on a first scan path and movement of the second imaging mast on a second scan path occur simultaneously.

3. The scanning system of claim 1, further comprising a floor imaging unit that includes one or more transmitters of electromagnetic radiation and one or more receivers of electromagnetic radiation, the one or more transmitters of the floor imaging unit configured to transmit radiation upwards from below a floor configured to support the object.

4. The scanning system of claim 3, wherein the computing device is further configured to execute instructions to receive imaging data from the one or more receivers of the floor imaging unit, and wherein the instruction to apply the reconstruction algorithm further comprises applying the reconstruction algorithm to imaging data from the first imaging mast, the second imaging mast, and the floor imaging unit to produce the image of at least the portion of the object.

5. The scanning system of claim 1, further comprising a non-invasive walk-through metal detector configured to detect the presence of metal or metallic objects within one or more spatial detection zones in a volume of space through which the object passes.

6. The scanning system of claim 5, wherein the volume of space includes an entrance to the detection system.

7. The scanning system of claim 5, wherein the computing device is further configured to execute instructions to receive data from the non-invasive walk-through metal detector identifying spatial detection zones where the presence of metal or metallic objects has been detected, and
wherein the instructions to apply the reconstruction algorithm further comprise applying the reconstruction algorithm to the imaging data from the first imaging mast and the second imaging mast and data from the non-invasive walk-through metal detector.

8. The scanning system of claim 1, wherein at least one of the plurality of second receivers on the second imaging mast is configured to receiver radiation transmitted by at least one of the plurality of first transmitters of the first imaging mast.

9. The scanning system of claim 1, wherein the reconstruction algorithm is a multistatic reconstruction algorithm.

10. The scanning system of claim 1, wherein the computing device is configured to receive imaging data before the first imaging mast and the second imaging mast begin moving.

11. The scanning system of claim 1, wherein the first imaging mast moves on a first arcuate scan path and the second imaging mast moves on a second arcuate scan path.

12. The scanning system of claim 1, wherein the first imaging mast moves on a first linear scan path and the second imaging mast moves on a second linear scan path.

13. The scanning system of claim 12, wherein the first imaging mast is configured to pivot about an axis perpendicular to the first linear scan path during motion of the first imaging mast on the first linear scan path such that the one or more receivers of the first imaging mast face the central point during the motion.

14. The scanning system of claim 1, wherein the first portion of the object overlaps at least in part with the second portion of the object.

15. The scanning system of claim 1, wherein the scanning system is a millimeter wave scanning system.

16. A method of scanning an object, comprising:
transmitting electromagnetic radiation from one of a plurality of transmitters of a first imaging mast or a second imaging mast;
receiving, at a computing device, imaging data indicative of receiving electromagnetic radiation scattered or reflected from the object by a plurality of first receivers of the first imaging mast and a plurality of second receivers of the second imaging mast;
moving the first imaging mast and the second imaging mast in unison in a common horizontal direction relative to a central horizontal axis; and
reconstructing an image of the object by applying a multistatic reconstruction algorithm of the computing device to the imaging data.

17. The method of claim 16, wherein movement of the first imaging mast on a first scan path and movement of the second imaging mast on a second scan path occur simultaneously.

18. The method of claim 16, further comprising:
receiving imaging data from one or more receivers of a floor imaging unit,
wherein reconstructing the image of the object further comprises applying a reconstruction algorithm to the imaging data from the floor imaging unit.

19. The method of claim 16, further comprising;
receiving data from a non-invasive walk-through metal detector identifying spatial detection zones where the presence of metal or metallic objects has been detected, and
wherein reconstructing the image of the object further comprises applying a reconstruction algorithm to the data from the non-invasive walk-through metal detector.

20. The method of claim 16, wherein at least one of the plurality of second receivers on the second imaging mast is configured to receive radiation transmitted by at least one of the plurality of transmitters of the first imaging mast.
